(19) United States
(12) Patent Application Publication
(10) Pub. No.: US 2025/0252651 A1
(43) Pub. Date: Aug. 7, 2025

(54) METHOD AND SYSTEM FOR NOVEL-VIEW IMAGE SYNTHESIS AND RENDERING, DEVICE AND MEDIUM

(71) Applicants: University of Electronic Science and Technology of China, Chengdu (CN); Sichuan Digital Economy Research Institute (Yibin), Yibin (CN)

(72) Inventors: Ning XIE, Chengdu (CN); Xin LOU, Chengdu (CN); Zengyu LIU, Chengdu (CN); Jingwen HE, Chengdu (CN); Sheng CAO, Chengdu (CN)

(73) Assignees: University of Electronic Science and Technology of China, Chengdu (CN); Sichuan Digital Economy Research Institute (Yibin), Yibin (CN)

(21) Appl. No.: 18/674,709

(22) Filed: May 24, 2024

(30) Foreign Application Priority Data
Feb. 4, 2024 (CN) 202410160144.7

(51) Int. Cl. G06T 15/04

(52) U.S. Cl. CPC G06T 15/04

(57) ABSTRACT

Provided are a method and system for novel-view image synthesis and rendering, a device and a medium. The method includes: acquiring initial information of a target model; performing neural texturing on the initial information to obtain neural texture (NT) information; and inputting the NT information to a synthesis rendering model to obtain a rendered image, where the synthesis rendering model includes an NT input module, an NT learning network module, and a differentiable renderer that are connected to each other; the NT input module receives the NT information, and transmits the NT information to the NT learning network module; the NT learning network module performs convolution and activation as well as concatenation on the NT information to obtain NT processed information; and the differentiable renderer adjusts and renders the NT processed information in a neural rendering manner to obtain the rendered image.

### CROSS REFERENCE TO RELATED APPLICATION

This patent application claims the benefit and priority of Chinese Patent Application No. 2024101601447 filed with the China National Intellectual Property Administration on Feb. 4, 2024, the disclosure of which is incorporated by reference herein in its entirety as part of the present application.

### TECHNICAL FIELD

The present disclosure relates to the field of image synthesis and rendering, and in particular to a method and system for novel-view image synthesis and rendering, a device and a medium.

### BACKGROUND

In modern production and life, due to complicated internal structures of materials, many transmissive jade models are researched hardly, particularly in novel view synthesis (NVS). A NVS task refers to rendering and generating an image corresponding to the target pose by given a source image, a source pose and a target pose. It is mainly applied to image restoration of cultural relics, and scene object pre-rendering. At present, the NVS of the jade transmission models are rarely researched in the rendering industry. The reasons for this include but are not limited to the following two points: Concerning the complicated rendering effect, in order to restore rendering in a real world, offline rendering is performed sometimes in advance to obtain results, but this is prone to segmentation from an existing real-time rendering pipeline to affect docking. Some simplified computational methods can also be used to simulate these materials, which satisfies real-time requirements but sacrifices some sense of reality.

### SUMMARY

An objective of the present disclosure is to provide a method and system for novel-view image synthesis and rendering, a device and a medium, to realize real-time and ground-truth (GT) synthesis and rendering of an image.

To achieve the above objective, the present disclosure provides the following technical solutions.

A method for novel-view image synthesis and rendering includes:
acquiring initial information of a target model, where the target model is a physical model of an experimental object; the initial information includes screen space information and auxiliary input information; the screen space information includes a diffuse reflection texture, a combined texture, and a normal texture; and the auxiliary input information includes a current view and a current light;
performing neural texturing on the initial information to obtain neural texture (NT) information; and
inputting the NT information to a synthesis rendering model to obtain a rendered image, the synthesis rendering model including an NT input module, an NT learning network module, and a differentiable renderer that are connected to each other,
where the NT input module is configured to receive the NT information, and transmit the NT information to the NT learning network module;
the NT learning network module is configured to perform convolution and activation as well as concatenation on the NT information to obtain NT processed information; and
the differentiable renderer is configured to adjust and render the NT processed information in a neural rendering manner to obtain the rendered image.

In the embodiment, the performing neural texturing on the initial information to obtain NT information includes:
sampling the initial information based on an NT structure to obtain a sampled result, the NT structure being a property encoding structure based on a neural network;
performing red green blue (RGB) color value conversion on the sampled result based on the NT structure to obtain rendering property information;
determining a feature map according to the rendering property information; and
decoding the feature map with a U-shaped network (U-Net) to obtain the NT information.

In the embodiment, a method for determining the synthesis rendering model includes:
acquiring training data of the target model at each view, the training data including initial information of known rendered images;
performing neural texturing on the initial information in the training data to obtain training NT information;
constructing a synthesis rendering network, the synthesis rendering network including the NT input module, the NT learning network module, and a training differentiable renderer that are connected in sequence;
transmitting the training NT information to the NT learning network module through the NT input module;
performing dilated convolution on the training NT information in the NT learning network module to obtain processed training NT information, and performing activation and concatenation on the processed training NT information based on a same resolution to obtain concatenated training data;
dividing the concatenated training data into a training set and a test set;
setting the training set and corresponding rendered images as an input of the training differentiable renderer, rendering the training set, and with a goal of minimizing a value of a loss function, updating parameters of the training differentiable renderer by using a gradient descent method and a back propagation method to obtain a trained differentiable renderer; and
setting the test set and corresponding rendered images as an input of the trained differentiable renderer, and adjusting parameters of the trained differentiable renderer to obtain the differentiable renderer,
where the synthesis rendering model includes the NT input module, the NT learning network module, and the differentiable renderer.

In the embodiment, adjusting and rendering, by the differentiable renderer, the NT processed information in the neural rendering manner to obtain the rendered image, comprises:
performing deferred rendering on the NT processed information in the neural rendering manner to obtain deferred rendering information data;
determining view rendering image data based on the auxiliary input information according to the deferred rendering information data; and
determining the rendered image according to the view rendering image data.

In the embodiment, the deferred rendering includes rasterization, interpolation calculation, texture mapping, and anti-aliasing.

A system for novel-view image synthesis and rendering includes:
an acquisition module, configured to acquire initial information of a target model, where the target model is a physical model of an experimental object; the initial information includes screen space information and auxiliary input information; the screen space information includes a diffuse reflection texture, a combined texture, and a normal texture; and the auxiliary input information includes a current view and a current light;
a processing module, configured to perform neural texturing on the initial information to obtain NT information; and
a rendering module, configured to input the NT information to a synthesis rendering model to obtain a rendered image, the synthesis rendering model including an NT input module, an NT learning network module, and a differentiable renderer that are connected to each other,
where the NT input module is configured to receive the NT information, and transmit the NT information to the NT learning network module;
the NT learning network module is configured to perform convolution and activation as well as concatenation on the NT information to obtain NT processed information; and
the differentiable renderer is configured to adjust and render the NT processed information in a neural rendering manner to obtain the rendered image.

An electronic device includes a memory and a processor, where the memory is configured to store a computer program, and the processor runs the computer program to enable the electronic device to execute the method for novel-view image synthesis and rendering.

A computer-readable storage medium stores a computer program, where the computer program is executed by a processor to implement the method for novel-view image synthesis and rendering.

According to specific embodiments provided in the present disclosure, the present disclosure has the following technical effects:

According to the method and system for novel-view image synthesis and rendering, the device and the medium provided by the present disclosure, initial information of a target model is acquired. Neural texturing is performed on the initial information to obtain NT information. The NT information is input to a synthesis rendering model to obtain a rendered image. The synthesis rendering model includes an NT input module, an NT learning network module, and a differentiable renderer that are connected to each other. The NT input module receives the NT information, and transmits the NT information to the NT learning network module. The NT learning network module performs convolution and activation as well as concatenation on the NT information to obtain NT processed information. The differentiable renderer adjusts and renders the NT processed information in a neural rendering manner to obtain the rendered image. The present disclosure can realize real-time and GT synthesis and rendering of an image.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a flowchart of a method for novel-view image synthesis and rendering according to an embodiment of the present disclosure;

FIG. 2 is a flowchart of an MLU-Net and an ML-block module according to an embodiment of the present disclosure;

FIG. 3 illustrates an framework of an overall network module MLU-Net; and

FIG. 4A and FIG. 4B are pictures illustrating a comparison of image effects.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

The present disclosure solves problems in the prior art well by designing a multi-link U-shape network (MLU-Net). On the basis of stacked U-Nets, the present disclosure uses a ML-Block module in multi-layer skip connection to solve the problem in NVS of a transmissive jade model.

An objective of the present disclosure is to provide a method and system for novel-view image synthesis and rendering, a device and a medium, to realize real-time and GT synthesis and rendering of an image.

In order to make the above objective, features and advantages of the present disclosure clearer and more comprehensible, the present disclosure will be further described in detail below in combination with accompanying drawings and particular implementation modes.

### Embodiment 1

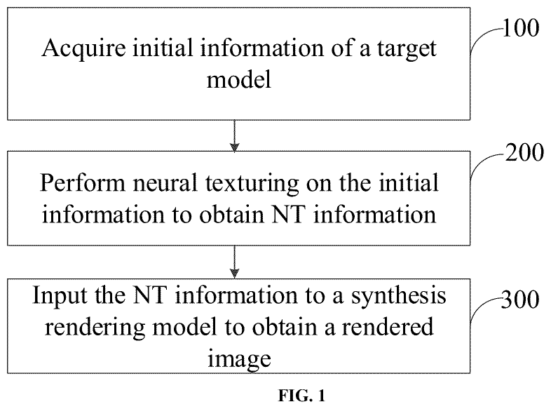

As shown in FIG. 1, the embodiment of the present disclosure provides a method for novel-view image synthesis and rendering, including the following steps 100 to 300.

In Step 100, initial information of a target model is acquired. The target model is a physical model of an experimental object. The initial information includes screen space information and auxiliary input information. The screen space information includes a diffuse reflection texture, a combined texture, and a normal texture. The auxiliary input information includes a current view and a current light.

In Step 200, neural texturing is performed on the initial information to obtain NT information.

The step that neural texturing is performed on the initial information to obtain NT information includes:

The initial information is sampled based on an NT structure to obtain a sampled result, the NT structure being a property encoding structure based on a neural network. RGB color value conversion is performed on the sampled result based on the NT structure to obtain rendering property information. A feature map is determined according to the rendering property information. The feature map is decoded by using a U-Net to obtain the NT information.

In Step 300, the NT information is input to a synthesis rendering model to obtain a rendered image. The synthesis rendering model includes an NT input module, an NT learning network module, and a differentiable renderer that are connected to each other.

The NT input module is configured to receive the NT information, and transmit the NT information to the NT learning network module. The NT learning network module is configured to perform convolution and activation as well as concatenation on the NT information to obtain NT processed information. The differentiable renderer is configured to adjust and render the NT processed information in a neural rendering manner to obtain the rendered image.

A method for determining the synthesis rendering model includes:

Training data of the target model at each view is acquired, the training data including initial information of known rendered images. Neural texturing is performed on the initial information in the training data to obtain training NT information. A synthesis rendering network is constructed, the synthesis rendering network including the NT input module, the NT learning network module, and a training differentiable renderer that are connected in sequence.

The training NT information is transmitted to the NT learning network module through the NT input module. Dilated convolution is performed on the training NT information in the NT learning network module to obtain processed training NT information, and activation and concatenation are performed on the processed training NT information based on a same resolution to obtain concatenated training data. The concatenated training data is divided into a training set and a test set.

The training set and corresponding rendered images are taken as an input of the training differentiable renderer, the training set is rendered, a minimum of a loss function is taken as a goal, and parameters of the training differentiable renderer are updated with a gradient descent method and a back propagation method to obtain a trained differentiable renderer.

The test set and corresponding rendered images are taken an input of the trained differentiable renderer, and parameters of the trained differentiable renderer are adjusted to obtain the differentiable renderer. The synthesis rendering model includes the NT input module, the NT learning network module, and the differentiable renderer.

In an embodiment, the differentiable renderer is configured to adjust and render the NT processed information in the neural rendering manner to obtain the rendered image, including:

Deferred rendering is performed on the NT processed information in the neural rendering manner to obtain deferred rendering information data. View rendering image data is determined based on the auxiliary input information according to the deferred rendering information data. The rendered image is determined according to the view render graph data. The deferred rendering includes rasterization, interpolation calculation, texture mapping, and anti-aliasing operation.

The present disclosure provides a method for NVS of a transmissive jade based on a novel neural network (hereinafter referred to as an MLU-Net). In the method, according to a model of specific type of jade material, a plurality of jade images at different views are generated, and UV information (U and V texture mapping coordinates, in which a U-axis refers to a horizontal direction, and a V-axis refers to a vertical direction), an illumination direction and an view direction of the model are calculated. Training is performed through the MLU-Net, and rendering is performed through a differentiable rasterization pipeline. Through continuous optimization, a GT transmission jade image at a novel view is obtained. Specific operation steps are as follow:

In Step 1: Operations including model and light source editing, camera view and rendering parameter setting, shading mode editing and other experimental data preprocessing are performed on a jade model with Blender software, to obtain essential information of NVS.

In Step 1.1: Initial information of a target model (which is the jade model and also the experimental object) is acquired with the blender software, the initial information includes screen space information, as well as auxiliary input information such as a current view and illumination.

The screen space information is acquired by following ways:

A camera is placed nearby the model to obtain information of the transmissive jade model. The information of the transmissive jade model refers to basic texture maps in physically based rendering (PBR) at a known view, including a diffuse reflection texture, a combined texture having a reflection coefficient of a specular surface, a roughness and a metallicity, and a normal texture, and a pre-integrated texture map. The four textures have a resolution of 512×512×3. Cycles serves as a rendering engine.

In Step 1.2: Neural texturing is performed on the initial information in Step 1.1. The NT refers to a novel and effective encoding structure on potential properties of a three-dimensional (3D) scene. Similar to a neural network, the NT can be learned, and can automatically optimize scene properties. Similar to conventional textures, such as a diffuse reflection texture, a normal texture and a displacement texture, the NT can be sampled to obtain information required by rendering. However, sampling of NT further needs to pass through a neural network. Final rendering properties can be obtained upon network computing on a sampled result. In other words, contents stored by the texture in the conventional rendering pipeline are converted into a set of implicit representations through RGB color values, such that the texture carries more information. Through rendering, a feature map composed of the implicit representations is obtained. The feature map contains more high-frequency information compared with an image obtained by conventional rendering. Then a high-quality rendered image can be generated by decoding the feature map through U-Net.

After NT information in the rendering is obtained, according to the current view, a UV coordinate of a PBR map and a UV coordinate of a pre-integrated map sampled at each effective pixel in a screen space are calculated. An NT is sampled, and an NT image is converted into a value in the screen space, and then transmitted to the network for optimized learning.

The NT refers to a novel and effective encoding structure on potential properties of a 3D scene. Similar to a neural network, the NT can be learned, and can automatically optimize scene properties. Similar to conventional textures, such as a diffuse reflection texture, a normal texture and a displacement texture, the NT can be sampled to obtain information required by rendering. However, sampling of NT further needs to pass through a neural network. Final rendering properties can be obtained upon network computing on a sampled result.

In Step 2: A novel network is designed to train neural rendering information at known views (about 30-70 views) of the jade model to obtain trained and well-performed information at a novel view, which then pass through a renderer for rendering, and is compared with a GT image at the novel view. The training is performed continuously, till a well-performed and trained image at the novel view is obtained finally.

In Step 2.1: A training set is acquired. The training set includes screen space information after neural rendering, auxiliary input information such as a current view and a current illumination, and known rendered images at a GT view (which is used as a GT value of the model result for comparison, so as to calculate a value of a loss function). This step is mainly intended to design an input of the network in the training set, thereby making a preparation for neural network training.

Information at each view after the neural texturing in Step 1.2 is processed. Each NT features has three channels. Moreover, there are also three channels in an illumination direction and three channels in a view direction. An 18-channel 512×512 feature matrix is transmitted to the neural network for learning. This is also the main inventive part. The overall network includes an NT input module, an NT learning network module, and a differentiable renderer. The former two modules serve as a main body of the network in learning. A differentiable texture and a user-defined U-Net are used to construct the NT. A rendering feature at each dimensionality is learned to the NT.

In Step 2.2: A structure of the neural network is designed. The neural network is trained and optimized based on the input of the training dataset in Step 1.1. Modifications are made on the user-defined U-Net. The network is first changed as a U2-Net (U2-Net:Goging Deeper with Nested U-Structure for Salient Object Detection). The network mainly includes several small U-Nets and a middle connecting portion. The 18-channel 512×512 feature matrix in Step 1.1 is input to a first small U-Net of an encoder for training to output a 64-channel 256×256 feature matrix, then pass through a second small U-Net of the encoder to output a 128-channel 128×128 feature matrix, subsequently pass through a third small U-Net of the encoder to output a 256-channel 64×64 feature matrix (analogously, a plurality of small U-Nets of the encoder can be added to double channels, and to halve a height and a weight of the feature matrix. Likewise, small U-Nets of a decoder with a corresponding size shall also be added to halve channels, and to double the height and the weight of the feature matrix). Dilated convolution is performed with the channels and the size of the feature matrix being unchanged. The 256-channel 64×64 feature matrix is input to the small U-Net of the decoder, such that the channels are halved to 128, and the size of the feature matrix is changed to 128×128. The output can be convolved as a desired 12-channel output. First, the output is in skip connection with a feature matrix of the encoder with a same channel resolution (through concatenation and convolution, the network is switched to an ML-Block), so as to keep the same channels. Second, the output is decoded continuously to halve the channels, and to double the height and the weight of the feature matrix. Third, the output is in skip connection with the feature matrix of the encoder with the same channel resolution, and pass through one small U-Net to halve the channels and double the height and the weight of the feature matrix, and subsequently the output is convolved as the desired 12-channel output. The 12-channel outputs of the three small U-Nets are combined together to serve as an overall 12-channel network output.

The encoder and the decoder in each small U-Net perform convolution, normalization, and processing of a Rectified Linear Unit (ReLU) activation function (which is a piecewise linear function, in which all negative values are changed into 0 and all positive values are unchanged), so as to adjust the channels and the resolution. The dilated convolution is to increase a receptive field (a region mapped on the original image by a pixel on a feature map output by each layer of the convolutional neural network) without changing the channels, and keep the height and the weight of the input feature map.

The network is proposed for the salient object detection. It is intended to highlight the most attractive object or region in the image. By mainly concatenating the output of each small U-Net, a key portion is highlighted. However, the direct use of the network will cause some unwanted noise. Herein, a module capable of reducing the noise and reducing a fine-grained size of the model is provided, and described below in detail. According to an existing NT matrix, in order to remove redundant fine-grained information, a skip connection structure is provided, so as to smooth the image and reduce the noise. Processing in each stage can be written as:

$$\begin{matrix}MidMatrix = ( DEOutputn ⊕ ENOutputn ) * KernelFunction \\ MidOutput n = ENOutputn * MidMatrix \\ DEOutputn = MidOutputn ⊕ DEOutputn\end{matrix} ,$$

where, ⊕ represents a matrix concatenation operation, represents an output of each encoder, and DEOutputn represents an output of each decoder. The final output of the decoder is in skip connection with the output of the corresponding encoder at the same dimension. In consideration of the previous concatenation, there are two concatenation operations. An obtained result is input to the next decoder. Descriptions will be made below in more detail.

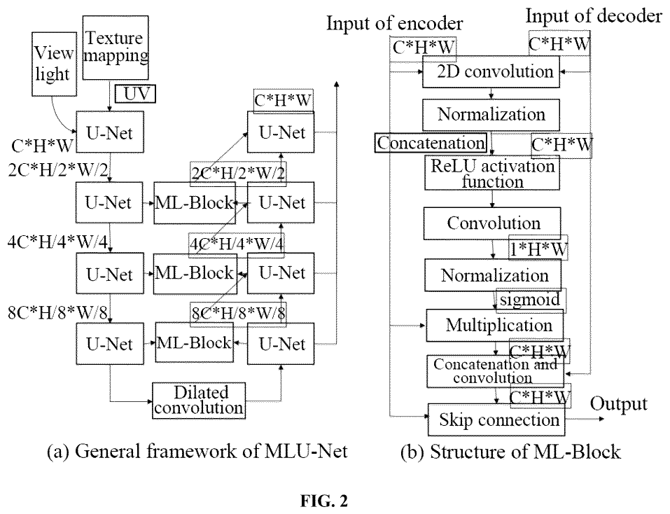

As shown in FIG. 2, the additional module ML-Block extracts an output of the small U-Net of the right decoder, and inputs the output to the next U-Net without skip connection. With the last module as an example, [b, c, h, w](batchsize, channels, height, weight) is [1, 512, 64, 64].
(1) The output and a feature map with a same resolution in the left encoder are subjected to two-dimensional (2D) convolution, such that desired four-dimensional (4D) outputs have same channels. Then, data normalization is performed. BatchNorm2d (a data normalization operation) is added following the convolutional layer to normalize data, such that the network does not perform unstably for the excessive data when the data is processed by a ReLU (an activation function).
(2) The two resultant outputs are fused, namely being added and concatenated together, to serve as an input of the ReLU activation function; then after using an activation function that increases a non-linear relation between layers of the neural network, is subjected to the 2D convolution again to reduce the channels to 1; and subsequently, after normalization, is subjected to an operation of a Sigmoid function (an activation function), that is, all values are changed to be between 0 and 1, which is equivalent to a weight matrix.

Multiplication is performed in a form of a weight and this is one part of the NT learning network module. Specifically, a weight matrix (obtained by performing convolution calculation, normalization and re-convolution on an output of the encoder and an output of the decoder with a same resolution, same channels and a same size) is multiplied by a feature output with the same resolution in the left encoder to serve as a new feature output with the same resolution in the left encoder.
(3) The new feature output with the same resolution in the encoder and the output of the decoder are concatenated together. As a result of concatenation, [b, c, h, w] is [1, 1024, 64, 64], the 2D convolution needs to be performed to halve the channels. Then, [b, c, h, w] is [1, 512, 64, 64]. The channels of the small U-Nets at different levels are different and but all halved.
(4) The output is taken as the output of the decoder and concatenated with the feature output with the same resolution in the left encoder. Thus, there are two concatenation operations. The later concatenation operation is different from the former concatenation operation for the skip connection.

In Step 2.3: An output of the neural network is obtained. The output of the neural network is 12-channel trained model information (including neural rendering matrix information of three basic texture maps and a pre-integrated texture map). For every three channels, deferred rendering is performed for comparison and optimization.

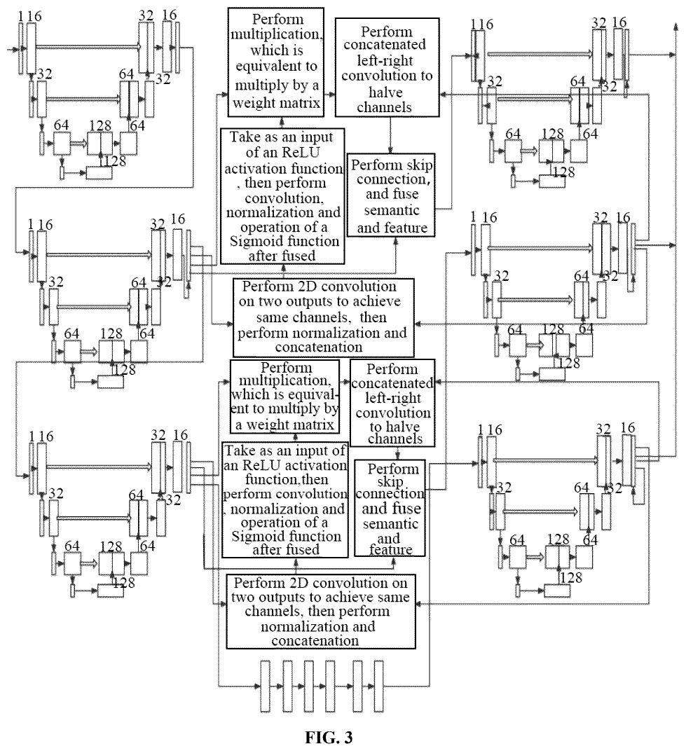

In Step 3: A well-trained result by the neural network (namely the 12-channel output of the neural network in Step 2.3) is put into a differentiable renderer for rendering, and converted into a rendered image at the view. The rendered image is compared with a rendered image at a known GT view (the nvidia differentiable renderer is used, Modular Primitives for High-Performance Differentiable Rendering, mainly including four steps: rasterization, interpolation calculation, texture mapping, and anti-aliasing), and deferred rendering is performed. In combination with rendering parameters such as an illumination direction and a light density, a rendered image at the novel view is obtained. The rendered image is compared with a Grand Truth (GT) image to obtain a loss value (an L1-loss function, an L1 norm loss), and is trained continuously for optimization (a gradient descent method (which is intended to seek a minimum along a gradient descent direction, and is mostly used to seek a model parameter in a machine learning algorithm. Through step-by-step iteration, a minimum of the loss function and the corresponding model parameter are obtained), and a Pytorch back propagation method (the back propagation method can propagate a gradient in a network, and perform gradient calculation at each node with a chain method, thereby completing parameter update of each node) are mainly used. Firstly a gradient in an optimizer is cleared, and then a gradient of the loss function on the model parameter is calculated, thereby realizing the back propagation method such that values of the network parameters are updated according to the gradient). The rendered image is trained for 10000 epochs (training times) to obtain a final result. The test set is used for testing. Comparison is made in a Root Mean Square Error (PSNR) and a Structural Similarity Index Measure (SSIM), thereby drawing a conclusion. In response to the NVS of the transmissive jade model, information of the jade model at some known views can be given in advance, encoded in a neural rendering manner in combination with an illumination direction and a view direction, trained through a designed network module, namely optimized through multi-layer skip connection, continuously optimized through two concatenation operations, and tested finally to obtain an image at a novel view. The obtained image is smooth, with little noise, a small fine granularity, so rendering effect is greatly improved. FIG. 3 illustrates an MLU-Net framework of an overall network module.

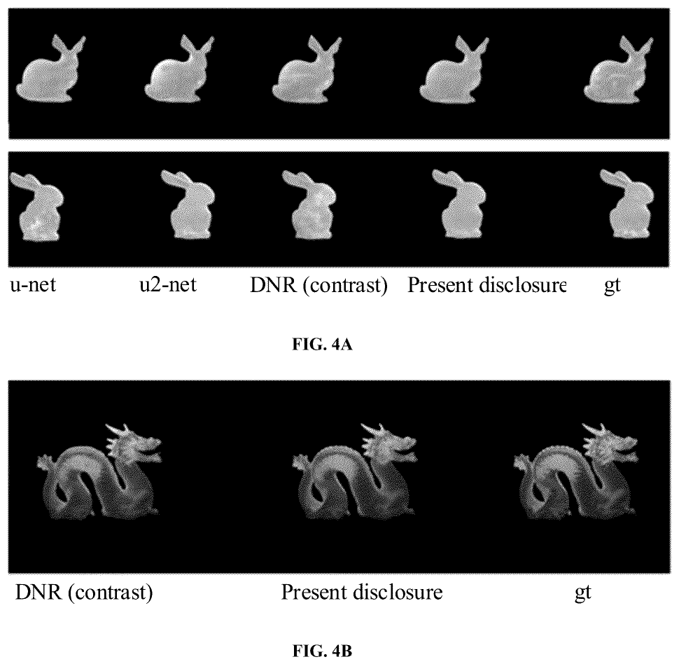

In comparison with the prior art, such as Deferred Neural Rendering: Image Synthesis using Neural Textures, the above-mentioned method has a high PSNR and a high SSIM, and is advantageous particularly in average smoothness color and gloss of the generated image. This advantage comes from ML Block, in which the output of the decoder and the output of the encoder are preprocessed and concatenated for two times, then a result serves as the input of the next decoder. This greatly reduces the noise of the decoder, and makes the image finer and smoother. FIG. 4A and FIG. 4B illustrate comparison of images.

### Embodiment 2

The embodiment of the present disclosure provides a system for novel-view image synthesis and rendering, including an acquisition module, a processing module, and a rendering module.

The acquisition module is configured to acquire initial information of a target model, where the target model is a physical model of an experimental object; the initial information includes screen space information and auxiliary input information; the screen space information includes a diffuse reflection texture, a combined texture, and a normal texture; and the auxiliary input information includes a current view and a current light.

The processing module is configured to perform neural texturing on the initial information to obtain NT information.

The rendering module is configured to input the NT information to a synthesis rendering model to obtain a rendered image, the synthesis rendering model including an NT input module, an NT learning network module, and a differentiable renderer that are connected to each other.

The NT input module is configured to receive the NT information, and transmit the NT information to the NT learning network module. The NT learning network module is configured to perform convolution and activation as well as concatenation on the NT information to obtain NT processed information. The differentiable renderer is configured to adjust and render the NT processed information in a neural rendering manner to obtain the rendered image.

### Embodiment 3

The embodiment of the present disclosure provides an electronic device, including a memory and a processor. The memory is configured to store a computer program, and the processor runs the computer program to enable the electronic device to execute the method for novel-view image synthesis and rendering in Embodiment 1.

An embodiment of the present disclosure further provides computer-readable storage medium. The computer-readable storage medium stores a computer program. The computer program is executed by a processor to implement the method for novel-view image synthesis and rendering in Embodiment 1.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A method for novel-view image synthesis and rendering, comprising:
acquiring initial information of a target model, wherein the target model is a physical model of an experimental object; the initial information comprises screen space information and auxiliary input information; the screen space information comprises a diffuse reflection texture, a combined texture, and a normal texture; and the auxiliary input information comprises a current view and a current light;
performing neural texturing on the initial information to obtain neural texture (NT) information; and
inputting the NT information to a synthesis rendering model to obtain a rendered image, the synthesis rendering model comprising an NT input module, an NT learning network module, and a differentiable renderer that are connected to each other,
wherein the NT input module is configured to receive the NT information, and transmit the NT information to the NT learning network module;
the NT learning network module is configured to perform convolution and activation as well as concatenation on the NT information to obtain NT processed information; and
the differentiable renderer is configured to adjust and render the NT processed information in a neural rendering manner to obtain the rendered image.

2. The method according to claim 1, wherein the performing neural texturing on the initial information to obtain NT information comprises:
sampling the initial information based on an NT structure to obtain a sampled result, the NT structure being a property encoding structure based on a neural network;
performing red green blue (RGB) color value conversion on the sampled result based on the NT structure to obtain rendering property information;
determining a feature map according to the rendering property information; and
decoding the feature map with a U-shaped network (U-Net) to obtain the NT information.

3. The method according to claim 1, wherein a method for determining the synthesis rendering model comprises:
acquiring training data of the target model at each view, the training data comprising initial information of known rendered images;
performing neural texturing on the initial information in the training data to obtain training NT information;
constructing a synthesis rendering network, the synthesis rendering network comprising the NT input module, the NT learning network module, and a training differentiable renderer that are connected in sequence;
transmitting the training NT information to the NT learning network module through the NT input module;
performing dilated convolution on the training NT information in the NT learning network module to obtain processed training NT information, and performing activation and concatenation on the processed training NT information based on a same resolution to obtain concatenated training data;
dividing the concatenated training data into a training set and a test set;
setting the training set and corresponding rendered images as an input of the training differentiable renderer, rendering the training set, and with a goal of minimizing a value of a loss function, updating parameters of the training differentiable renderer by using a gradient descent method and a back propagation method to obtain a trained differentiable renderer; and
setting the test set and corresponding rendered images as an input of the trained differentiable renderer, and adjusting parameters of the trained differentiable renderer to obtain the differentiable renderer,
wherein the synthesis rendering model comprises the NT input module, the NT learning network module, and the differentiable renderer.

4. The method according to claim 1, wherein adjusting and rendering, by the differentiable renderer, the NT processed information in the neural rendering manner to obtain the rendered image, comprises:
performing deferred rendering on the NT processed information in the neural rendering manner to obtain deferred rendering information data;
determining view rendering image data based on the auxiliary input information according to the deferred rendering information data; and
determining the rendered image according to the view rendering image data.

5. The method according to claim 4, wherein the deferred rendering comprises rasterization, interpolation calculation, texture mapping, and anti-aliasing.

6. A system for novel-view image synthesis and rendering, comprising:
an acquisition module, configured to acquire initial information of a target model, wherein the target model is a physical model of an experimental object; the initial information comprises screen space information and auxiliary input information; the screen space information comprises a diffuse reflection texture, a combined texture, and a normal texture; and the auxiliary input information comprises a current view and a current light;
a processing module, configured to perform neural texturing on the initial information to obtain neural texture (NT) information; and
a rendering module, configured to input the NT information to a synthesis rendering model to obtain a rendered image, the synthesis rendering model comprising an NT input module, an NT learning network module, and a differentiable renderer that are connected to each other,
wherein the NT input module is configured to receive the NT information, and transmit the NT information to the NT learning network module;
the NT learning network module is configured to perform convolution and activation as well as concatenation on the NT information to obtain NT processed information; and
the differentiable renderer is configured to adjust and render the NT processed information in a neural rendering manner to obtain the rendered image.

7. An electronic device, comprising a memory and a processor, wherein the memory is configured to store a computer program, and the processor runs the computer program to enable the electronic device to execute the method according to claim 1.

8. The electronic device according to claim 7, the processor runs the computer program to enable the electronic device to execute the method of:
sampling the initial information based on an NT structure to obtain a sampled result, the NT structure being a property encoding structure based on a neural network;
performing red green blue (RGB) color value conversion on the sampled result based on the NT structure to obtain rendering property information;
determining a feature map according to the rendering property information; and
decoding the feature map with a U-shaped network (U-Net) to obtain the NT information.

9. The electronic device according to claim 7, the processor runs the computer program to enable the electronic device to execute the method of:
acquiring training data of the target model at each view, the training data comprising initial information of known rendered images;
performing neural texturing on the initial information in the training data to obtain training NT information;
constructing a synthesis rendering network, the synthesis rendering network comprising the NT input module, the NT learning network module, and a training differentiable renderer that are connected in sequence;
transmitting the training NT information to the NT learning network module through the NT input module;
performing dilated convolution on the training NT information in the NT learning network module to obtain processed training NT information, and performing activation and concatenation on the processed training NT information based on a same resolution to obtain concatenated training data;
dividing the concatenated training data into a training set and a test set;
setting the training set and corresponding rendered images as an input of the training differentiable renderer, rendering the training set, and with a goal of minimizing a value of a loss function, updating parameters of the training differentiable renderer by using a gradient descent method and a back propagation method to obtain a trained differentiable renderer; and
setting the test set and corresponding rendered images as an input of the trained differentiable renderer, and adjusting parameters of the trained differentiable renderer to obtain the differentiable renderer,
wherein the synthesis rendering model comprises the NT input module, the NT learning network module, and the differentiable renderer.

10. The electronic device according to claim 7, the processor runs the computer program to enable the electronic device to execute the method of:
performing deferred rendering on the NT processed information in the neural rendering manner to obtain deferred rendering information data;
determining view rendering image data based on the auxiliary input information according to the deferred rendering information data; and
determining the rendered image according to the view rendering image data.

11. The electronic device according to claim 10, wherein the deferred rendering comprises rasterization, interpolation calculation, texture mapping, and anti-aliasing.

12. A non-transitory computer-readable storage medium, wherein the computer-readable storage medium stores a computer program, and the computer program is executed by a processor to implement the method according to claim 1.

13. The non-transitory computer-readable storage medium according to claim 12, the computer program is executed by a processor to implement the method of:
sampling the initial information based on an NT structure to obtain a sampled result, the NT structure being a property encoding structure based on a neural network;
performing red green blue (RGB) color value conversion on the sampled result based on the NT structure to obtain rendering property information;
determining a feature map according to the rendering property information; and
decoding the feature map with a U-shaped network (U-Net) to obtain the NT information.

14. The non-transitory computer-readable storage medium according to claim 12, the computer program is executed by a processor to implement the method of:
acquiring training data of the target model at each view, the training data comprising initial information of known rendered images;
performing neural texturing on the initial information in the training data to obtain training NT information;
constructing a synthesis rendering network, the synthesis rendering network comprising the NT input module, the NT learning network module, and a training differentiable renderer that are connected in sequence;
transmitting the training NT information to the NT learning network module through the NT input module;
performing dilated convolution on the training NT information in the NT learning network module to obtain processed training NT information, and performing activation and concatenation on the processed training NT information based on a same resolution to obtain concatenated training data;
dividing the concatenated training data into a training set and a test set;
setting the training set and corresponding rendered images as an input of the training differentiable renderer, rendering the training set, and with a goal of minimizing a value of a loss function, updating parameters of the training differentiable renderer by using a gradient descent method and a back propagation method to obtain a trained differentiable renderer; and
setting the test set and corresponding rendered images as an input of the trained differentiable renderer, and adjusting parameters of the trained differentiable renderer to obtain the differentiable renderer,
wherein the synthesis rendering model comprises the NT input module, the NT learning network module, and the differentiable renderer.

15. The non-transitory computer-readable storage medium according to claim 12, the computer program is executed by a processor to implement the method of:
performing deferred rendering on the NT processed information in the neural rendering manner to obtain deferred rendering information data;
determining view rendering image data based on the auxiliary input information according to the deferred rendering information data; and
determining the rendered image according to the view rendering image data.

16. The non-transitory computer-readable storage medium according to claim 15, wherein the deferred rendering comprises rasterization, interpolation calculation, texture mapping, and anti-aliasing.
